(19) United States
(12) Patent Application Publication
(10) Pub. No.: US 2023/0288354 A1
(43) Pub. Date: Sep. 14, 2023

(54) DEEP REINFORCEMENT LEARNING-ENABLED CRYO-EM DATA COLLECTION

(71) Applicants: REGENTS OF THE UNIVERSITY OF MICHIGAN, Ann Arbor, MI (US); INTERNATIONAL BUSINESS MACHINES CORPORATION, Armonk, NY (US); MASSACHUSETTS INSTITUTE OF TECHNOLOGY, Cambridge, MA (US)

(72) Inventors: Michael Cianfrocco, Ann Arbor, MI (US); Quanfu Fan, Lexington, MA (US); Yilai Li, Ann Arbor, MI (US); Seychelle Vos, Cambridge, MA (US)

(21) Appl. No.: 18/119,117

(22) Filed: Mar. 8, 2023

Related U.S. Application Data
(60) Provisional application No. 63/317,858, filed on Mar. 8, 2022.

(51) Int. Cl. G01N 23/2251; G06T 7/00

(52) U.S. Cl. CPC G01N 23/2251; G06T 7/97; G06T 2207/10061; G06T 2207/20084

(57) ABSTRACT

Methods and systems for performing electron microscopy are provided. Microscopy images candidate sub-regions at different magnification levels are captured and provided to a trained sub-region quality assessment application trained to output a quality score for each candidate sub-region. From the quality scores, group-level features for the larger magnification images are determined using a group-level feature extraction application. The quality scores for the candidate sub-regions and the group-level extraction features are provided to a trained Q-learning network that identifies a next sub-region amongst the candidate sub-regions for capturing a micrograph image, where reinforcement learning may be used with the Q-learning network for such identification, for example using a decisional cost.

### CROSS-REFERENCE TO RELATED APPLICATIONS

This application claims priority to U.S. Provisional Patent Application No. 63/317,858, filed Mar. 8, 2022, the entire disclosure of which is incorporated herein by reference.

### STATEMENT OF GOVERNMENT SUPPORT

This invention was made with government support under 1759826 awarded by the National Science Foundation. The government has certain rights in the invention.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Single-particle cryo-electron microscopy (cryo-EM) has become one of the mainstream techniques for analyzing bio-molecular structures due to an ability to solve structures with moderate heterogeneity and without the need for crystallization. Further, software development has led to automation in both data collection and image processing, which, along with improvements in detectors and microscope techniques, has dramatically accelerated data acquisition.

More recently, cryo-EM has served as a valuable tool in the development of vaccines and therapeutics to combat COVID-19 by SARS-CoV-2 (see, FIG. 1 showing a representation of micrographs images 100 and a three-dimensional (3D) rendition 102 of the SARS-CoV-2 spike protein 102 constructed from micrographs). Within weeks of the release of the genomic sequence of SARS-CoV-2, cryo-EM was used to determine the first SARS-CoV-2 spike protein structure. Since then, 400+ cryo-EM structures have been deposited into the EM-DataBank, including spike protein bound to antibody fragments, remdesivir bound to SARS-CoV-2 RNA-dependent RNA polymerase, and reconstructions of intact SARS-CoV-2 virions.

Despite these advances, cryo-EM data collection remains ad-hoc, rudimentary, and subjective. Because sample quality can vary substantially across a cryo-EM grid, images are acquired at different magnifications ranging from resolutions of 0.66 mm to 500 Angstroms. Significant user expertise is then required to define locations that are suitable for data collection. To provide objective feedback, “on-the-fly” image processing can confirm high-quality regions on the cryo-EM sample. Despite this feedback, however, data collection remains highly subjective.

Cryo-EM is also expensive, further compounding challenges faced by users. Equipment is expensive, as are operating costs for computationally complex data collection and analysis. There is a significant need among structural biologists for methods to collect the best Cyro-EM data possible in a limited amount of time.

### SUMMARY OF THE INVENTION

In an aspect, a method for performing electron microscopy on a sample, the method includes: receiving, by one or more processors, images of a grid structure comprising a plurality of sub-regions, wherein the images of the grid structure contain (i) a first subset of candidate sub-region images captured at a first magnification level and each of a different candidate sub-region and (ii) one or more group-level images captured at a second magnification level and containing a plurality of the different candidate sub-region; providing, by the one or more processors, the first subset of the images to a trained sub-region quality assessment application and outputting, from the trained sub-region quality assessment application, a quality score for each candidate sub-region; generating, by the one or more processors, from the quality scores for each candidate sub-region image, group-level features for the group-level images, using a group-level feature extraction application; applying, by the one or more processors, the quality scores for each of the candidate sub-region images and the group-level extraction features to a trained Q-learning network, the trained Q-learning network determining Q-values for each candidate sub-region and identifying a next sub-region amongst the candidate sub-regions; and capturing one or more a micrograph images of the next sub-region.

In an example, the trained sub-region quality assessment application is configured to classify each candidate sub-region based on contrast transfer function metrics.

In an example, the trained sub-region quality assessment application is configured to classify each candidate sub-region has having a low quality or a high quality based on contrast transfer function metrics.

In an example, the trained sub-region quality assessment application is a supervised classifier.

In an example, the trained sub-region quality assessment application is a regression-based classifier.

In an example, the candidate sub-regions are geometrical hole-shaped regions.

In an example, each sub-region of the grid is sized to contain a single particle of the sample.

In an example, the trained Q-learning network is a multi-fully-connected layer deep Q-network configuration.

In an example, a fully-connected layer of the trained Q-learning network comprises a plurality of observation state and action pairs.

In an example, the trained Q-learning network is a deep reinforcement learning network.

In an example, the method further includes: in response to capturing the micrograph image of the next sub-region, determining a reward score of the micrograph image of the next sub-region; providing the reward score of the micrograph image of the next sub-region to the trained Q-learning network; and updating a rewards decision of the trained Q-learning network for determining Q-values for subsequent candidate sub-regions.

In an example, the trained Q-learning network is configured to identify the next sub-region by determining a decisional cost associated with imaging each candidate sub-region and identifying, as the next sub-region, the candidate sub-region with the lowest decisional cost.

In an example, the group-level images comprise patch-level images each of a patch-level region containing a plurality of the candidate sub-regions, square-level images each of a square-level region containing a plurality of the patch-level regions, and/or grid-level images each of a grid-level region containing a plurality of square-level regions.

In an example, generating the group-level extraction features comprises determining, for each group-level image, a number of candidate sub-regions, a number of previously imaged sub-regions, a number of candidate sub-regions with a low quality score, and/or a number of candidate sub-regions with a high quality score.

In another aspect, a system for performing electron microscopy on a sample, the system includes: one or more processors; and a deep-reinforcement learning platform including a trained sub-region quality assessment application, a feature extraction application, and trained Q-learning network; wherein the deep-reinforcement learning platform includes computing instructions configured to be executed by the one or more processors to: receive images of a grid structure comprising a plurality of sub-regions, wherein the images of the grid structure contain (i) a first subset of candidate sub-region images captured at a first magnification level and each of a different candidate sub-region and (ii) one or more group-level images captured at a second magnification level and containing a plurality of the different candidate sub-region; and provide the first subset of the images to the trained sub-region quality assessment application; wherein the trained sub-region quality assessment application includes computing instructions configured to be executed by the one or more processors to determine and output a quality score for each candidate sub-region; wherein the feature extraction application includes computing instructions configured to be executed by the one or more processors to: generate from the quality scores for each candidate sub-region image, group-level features for the group-level images; and apply the quality scores for each of the candidate sub-region images and the group-level extraction features to the trained Q-learning network; wherein the trained Q-learning network includes computing instructions configured to be executed by the one or more processors to determine Q-values for each candidate sub-region and identify a next sub-region amongst the candidate sub-regions.

In an example, the deep-reinforcement learning platform including a rewards application, wherein the rewards application includes computing instructions configured to be executed by the one or more processors to: in response to capturing a micrograph image of the next sub-region, determine a reward score of the micrograph image of the next sub-region; and provide the reward score of the micrograph image of the next sub-region to the trained Q-learning network; and wherein the trained sub-region quality assessment application includes computing instructions configured to be executed by the one or more processors to update the trained Q-learning network for determining Q-values for subsequent candidate sub-regions.

In yet another aspect, a non-transitory computer-readable storage medium storing executable instructions that, when executed by a processor, cause a computer to: receive, by one or more processors, images of a grid structure comprising a plurality of sub-regions, wherein the images of the grid structure contain (i) a first subset of candidate sub-region images captured at a first magnification level and each of a different candidate sub-region and (ii) one or more group-level images captured at a second magnification level and containing a plurality of the different candidate sub-region; provide, by the one or more processors, the first subset of the images to a trained sub-region quality assessment application and output, from the trained sub-region quality assessment application, a quality score for each candidate sub-region; generate, by the one or more processors, from the quality scores for each candidate sub-region image, group-level features for the group-level images, using a group-level feature extraction application; apply, by the one or more processors, the quality scores for each of the candidate sub-region images and the group-level extraction features to a trained Q-learning network, the trained Q-learning network determining Q-values for each candidate sub-region and identifying a next sub-region amongst the candidate sub-regions; and capture one or more a micrograph images of the next sub-region.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 illustrates a stack of micrograph images and a 3D reconstruction of the SARS-CoV-2 spike protein 102 reconstructed from micrographs, using standard techniques.

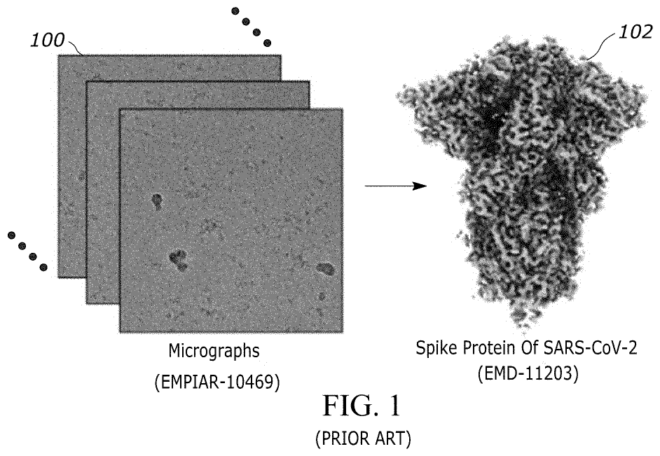

FIG. 2 illustrates a cryogenic electron microscopy (cryo-EM) sample and different images of a grid structure onto which the sample is provided, the different images being captured at different magnification levels and representing images that may be consumed and/or generated in accordance with examples herein.

FIG. 3 is a schematic diagram of a system for performing electron microscopy using deep-reinforcement learning techniques, in accordance with an example.

FIG. 4 illustrates an example processing flow of the system of FIG. 3, in accordance with an example.

FIG. 5 is a process for performing electron microscopy using deep-reinforcement learning techniques as may be implemented by the system of FIG. 1 and/or the processing flow of FIG. 2, in accordance with an example.

FIG. 6 is a schematic illustration of a path showing an electron microscope movement planned in a data collection session, in accordance with an example. Different microscopic operations are associated with different costs, which are indicated by the edge width.

FIG. 7 is a schematic illustration of an example architecture of deep Q-learning network (DQN), the network having only one single output node to estimate the Q-value for an action-state pair, in accordance with an example.

FIG. 8 is a plot showing the performance (total # of ICTFs found) of the process of FIG. 4 in different configurations (cryoRL_R18 and cryoRL_R50) compared to greedy policy baseline examples (greedy_R18 and greedy_R50) by duration, in accordance with an example.

FIGS. 9A-9F illustrate data collection approaches for the present techniques and for human subjects, in accordance with an example. A graph node denotes a patch in data and the size of a node indicates the quality of the patch (e.g., the number of low-CTF holes). Patches from the same grid are grouped by color and linked by light grey edges. The blue edges show the frequency of a pair of patches visited by the microscope. FIG. 9A illustrates a ground truth-based implementation and FIG. 9B illustrates an R50-based implementation, of the present techniques. FIG. 9C illustrates a user policy, FIG. 9D illustrates a ground-truth based user policy, FIG. 9E illustrates a R50-based user policy, and FIG. 9F illustrates a user path.

### DETAILED DESCRIPTION

Systems and methods are provided for electron microscopy (EM) imaging, where images are captured at different image magnifications to allow for micrograph imaging of a sample, for example to analyze the architecture of cells, viruses, and protein assemblies at molecular resolution. More particularly, the present techniques may be used for in cryogenic electron microscopy (cryo-EM). Foundationally, various approaches herein formulate EM data collection as an optimization task that results in systems and methods that deploy intelligent strategies, obtained from image data, to guide microscope movement during an EM procedure. In some examples, the optimization problem is solved by combining supervised classification and deep reinforcement learning (RL). In some examples, systems and methods include a new data acquisition algorithm that enables data collection with no subjective decisions, much less user intervention, and does so with increased efficiency over conventional systems. In some examples, the techniques provide an artificial intelligence (AI))-based algorithm that is used to control EM (e.g., cryo-EM) data acquisition, with a learning strategy that optimizes microscope movement and scanning to scan a sample region in a more efficient manner.

There are currently no automated cryo-EM data collection approaches. Instead, subjective decision-making drives cryo-EM data acquisition. To guide user-driven data collection, for example, “on-the-fly” image analysis provides results on data quality, including Lander et al., “Appion: an integrated, database-driven pipeline to facilitate em image processing,” Journal of structural biology, 166(1):95-102, 2009, Tegunov et al., “Real-time cryo-electron microscopy data preprocessing with warp,” Nature methods 16(11):1146-1152 (2019), and cryoSPARC Live that must be interpreted by users help user decisions for data collection areas. To provide more objective measures of data quality to users, researchers have developed a pre-trained deep learning-based micrograph assessment models and downstream on-the-fly data processing. However, despite these efforts, on-the-fly processing requires a sizeable number of micrographs before providing useful feedback. Data collection requires user training to develop expertise to guide data collection in the most efficient manner possible.

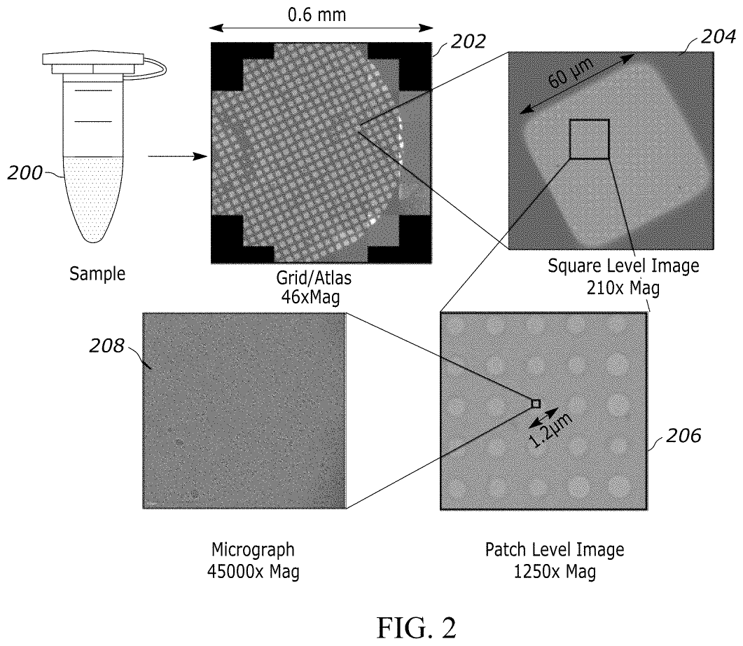

FIG. 2 illustrates an example general-purpose data acquisition regime for cryo-EM applications and that represents images that may be consumed and/or generated from the EM systems and methods described herein. Typically, a purified biological sample 200 is dispensed and vitrified onto a grid formed of gold or copper support bars. In an example, cryo-EM procedure, images of the grid are captured in a grid-level image 202 (e.g., 40× magnification). The grid-level image 202 contains a mesh of squares shown in a square-level image 204 (e.g., 210× magnification), and each square has a lattice of regularly-spaced holes, shown in a patch-level image 206 (e.g., 1250× magnification). Ideally, within each hole, there are vitrified single particles related to the sample of interest. Data collection may amount to recording images of holes (and sub-hole areas) as micrographs 208 (e.g., 45000× magnification). In conventional systems, a user decides which of these holes to take micrographs from, where these micrographs contain high-resolution images for downstream processing. However, these cryo-EM images 202-208 can exhibit great heterogeneity across the sample 200. Whereas there are many local correlations between squares and holes on the grid, many holes are empty, aggregated, or contain non-vitreous ice contamination. In a conventional system, the user has no prior knowledge of such distribution until cryo-EM image data is manually examined, at the square-level image 204 or at the hole-level image 208, where these different image levels are captured with a microscope by changing to different magnifications. Moreover, because the time on the microscope is precious and limited, data collection may typically only cover less than 1% of the total grid-level image 202, which means the user needs to navigate through the “grid-square-hole” hierarchy and collect the best micrographs in a limited time.

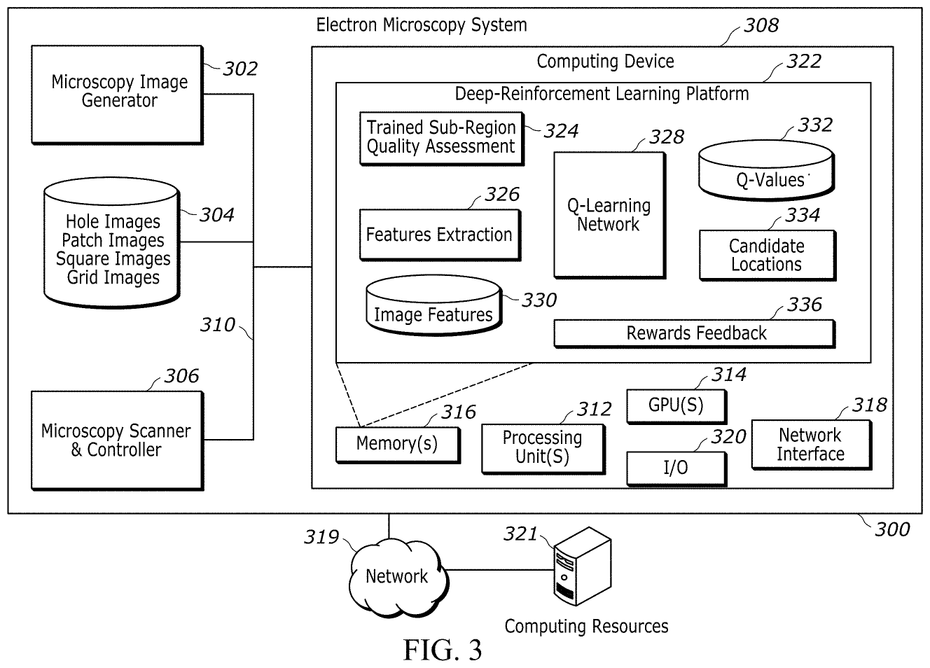

FIG. 3 illustrates an electron microscopy system 300 that provides optimized electron microscopy scanning through improved data acquisition and processing to generate the cryo-EM images 202-208 in a more efficient manner, by using an optimized order and image acquisition. The electron microscopy system 300 determines optimized locations for scanning of the sample, through examining images captured at different magnifications. The electron microscopy system 300 uses data collection processes, in particular a deep-reinforcement learning framework, and determines overall data collection routes for image capture across the sample (e.g., the grid onto which the sample is provided) in an optimized order. In the illustrated example, the systems 300 is configured based on a few assumptions: that there is a pre-selection of squares for imaging a portion of a sample, that each square has patch-level images, and that a corresponding high-magnification micrograph can be taken from each hole or location. Each micrograph has an objective measure of data quality, which is the goodness-of-fit for the frequency domain when estimating the defocus of the micrograph.

The electron microscopy system 300 includes an imager 302 capable of capture images of a sample, which may be within a sample holder or chamber (not shown), at different magnification levels, such as at a grid-level, square-level, patch-level, and/or micrograph level. The captured images may be stored in database 304, for example. The images may be of a grid structure, such as for example a cryo-EM grid. The position (and in some examples, the magnification) of the imager 302 may be controlled by a scanner and controller 306. The image 302, the database 304, and the controller 306 are coupled to a computing device 308 through a data bus 310.

The computing device 308 includes one or more processing units 312, one or more optional graphics processing units 314, a local database (not shown), a computer-readable memory 316, a network interface 318, and Input/Output (I/O) interfaces 320 connecting the computing device 308 to a display (not shown) and user input device (not shown).

The computing device 308 may be implemented on a single computer processing device or multiple computer processing devices. The computing device 308 may be implemented on a network accessible computer processing device, such as a server, or implemented across distributed devices connected to one another through a communication link. In other examples, functionality of the computing device 308 may be distributed across any number of devices, including the portable personal computer, smart phone, electronic document, tablet, and desktop personal computer devices shown. In other examples, the functionality of the computing device 308 may be cloud based, such as, for example one or more connected cloud CPU (s) customized to perform machine learning processes and computational techniques herein. In the illustrated example, the network interface 318 is connected to a network 319 which may be a public network such as the Internet, private network such as research institution's or corporation's private network, or any combination thereof. Networks can include, local area network (LAN), wide area network (WAN), cellular, satellite, or other network infrastructure, whether wireless or wired. The network can utilize communications protocols, including packet-based and/or datagram-based protocols such as internet protocol (IP), transmission control protocol (TCP), user datagram protocol (UDP), or other types of protocols. Moreover, the network 104 can include a number of devices that facilitate network communications and/or form a hardware basis for the networks, such as switches, routers, gateways, access points (such as a wireless access point as shown), firewalls, base stations, repeaters, backbone devices, etc. In the illustrated example, the electron microscopy system 300 is connected to computing resources 321 through the network 319.

The memory 316 may be a computer-readable media and may include executable computer-readable code stored thereon for programming a computer (e.g., comprising a processor(s) and GPU(s)) to the techniques herein. Examples of such computer-readable storage media include a hard disk, a CD-ROM, digital versatile disks (DVDs), an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. More generally, the processing units 312 of the computing device 308 may represent a CPU-type processing unit, a GPU-type processing unit, a field-programmable gate array (FPGA), another class of digital signal processor (DSP), or other hardware logic components that can be driven by a CPU.

In the illustrated example, in addition to storing operating system, the memory 316 stores a deep-reinforcement learning platform 322, configured to execute various processes described and illustrated herein. In an example, the deep-reinforcement learning platform 322 is configured to receive images from the database 304, e.g., images of a grid structure containing a sample, where those images include subsets of images captured at different magnification levels. The deep-reinforcement learning platform 322 is configured output a quality score for a series of candidate sub-regions and generate from these quality scores group-level features, which may be used along with the quality scores to identify a next sub-region of the sample to image, after which that next sub-region is imaged. The deep-reinforcement learning platform may be implemented using machine learning algorithms combing deep learning with reinforcement learning, using neural networks.

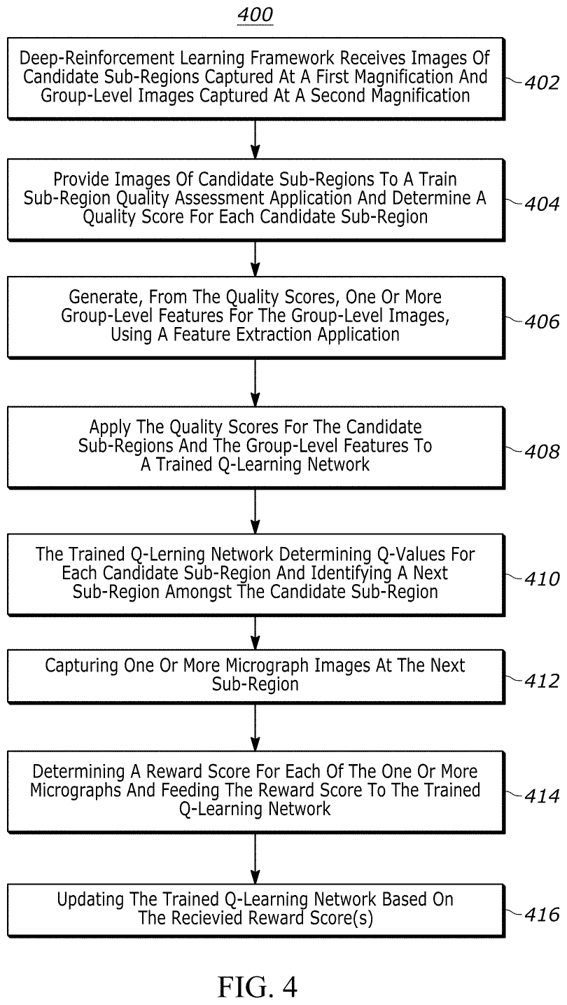

In the illustrated example, the deep-reinforcement learning platform 322 includes a trained sub-region quality assessment application 324, a features extraction application 326, and Q-learning network application 328. In some examples, the applications 324, 326, and 328 may be implemented as separate trained machine learning algorithms, e.g., separate neural networks, of the deep-reinforcement learning platform 322. In some examples, one or more of the applications 324, 326, and 328 may implemented in a single trained machine learning algorithm, e.g., in the form of a neural network. In some examples, one or more of the applications 324, 326, and 328 may implemented as different lawyers in the deep learning neural network. As discussed in further examples herein, and referencing example process 400 in FIG. 4, the trained sub-region quality assessment application 324 receives images from the database 304 or directly from the imager 302 (at process 402) and performs a quality assessment on the images (at a process 404), for example, by examining images capture at a high magnification, such as at a path-level and/or square-level and determining a quality score for each sub-region in those images. A sub-region may represent, at the lowest level, a single hole. Although the sub-region may represent, a plurality of holes. While holes are described in some examples herein, a hole merely presents a location in the grid or more broadly a location in a sample. For example, a grid may be formed of a series of different locations that may be imaged at the micrograph level in a cryo-EM application. The term hole refers to any geometrical hole-shaped location, which may be a cylindrical shape, rectangular shape, hexagonal shape, elliptical shape, or any shape to be imaged at the highest magnification of the system. From these quality scores of sub-regions, the features extraction application 326 (at a process 406) may examine images at lower magnification levels (e.g., square-level and/or grid-level) and extract group-level features which are stored in an image features database 330. These group-level features 330 are provided to the Q-learning network (process 408), which is trained to determine Q-values for each candidate sub-region and identify a next sub-region amongst those candidate sub-regions (process 410), where the imager 302 is to image. The generated Q-values may be stored in a database 332 and the candidate sub-regions, including the next sub-region, may be stored at memory location 334. The deep-reinforcement learning platform 322 may communicate the next sub-region to the scanner and controller 306, through the data bus 310, which may then move the imager 302 to a new location to capture a subsequent image (process 412), in particular an image at a micrograph level (e.g., a hole-level) and the process may start again. In some examples, the captured micrograph image is also applied to a rewards application 336 (process 414), which determines a reward score for that captured micrograph image and feeds that reward score to the Q-learning network 328 (process 416), which then is retrained to adjust its configuration, as determined, based on that reward score. For example, if the captured micrograph image is of a low quality and results in a low rewards score, then the Q-learning network will use that training data to adjust the parameters of its deep learning framework to adjust how a future next sub-region is determined. In this way, as the deep reinforcement learning platform 322 identifies new next sub-regions to image, it is able to optimize itself after each iteration through a rewards feedback process.

In some examples, the trained sub-region quality assessment application 324 is configured to classify each candidate sub-region based on contrast transfer function metrics. For example, the application 324 may be configured to classify each candidate sub-region has having a low quality or a high quality based on contrast transfer function metrics. In some examples, the application 324 is a supervised classifier or a regression-based classifier. The candidate sub-regions may be geometrical hole-shaped regions sized to contain a single particle of the sample or many single particles of the same, such as 10 or fewer, 100 or fewer, or a 1000 or fewer.

As discussed in further examples herein, the trained Q-learning network application 328 may have a deep-reinforcement learning configuration that contains multiple fully-connected layers. In some examples, at least one fully-connected layer includes a plurality of observation state and action pairs. In some examples, the trained Q-learning network application 328 is configured to identify the next sub-region by determining a decisional cost associated with imaging each candidate sub-region and identifying, as the next sub-region, the candidate sub-region with the lowest decisional cost. In various examples, the decisional cost is a numerical expression or value output from a decision rule, e.g., a function that maps an observation to an appropriate action to maximize the quality of the input dataset to that decision rule. In various examples, minimizing the decisional cost is used to determine the next candidate sub-region.

### Example Cryo-EM System Operation

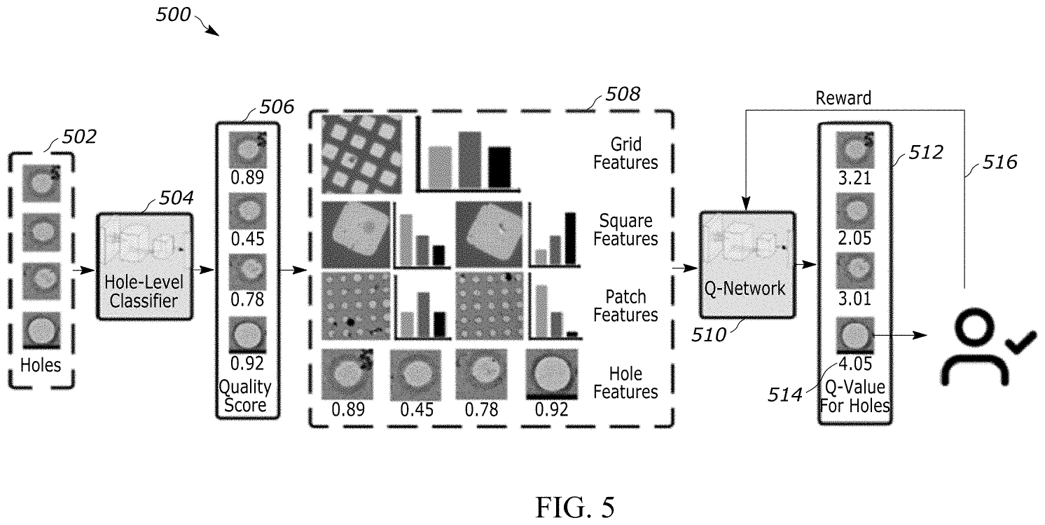

FIG. 5 illustrates an example implementation 500 of the operation of the deep-reinforcement learning platform 322 that combines an image classifier and a reinforcement learning network to enable automatic planning of electron microscope movement. In the example implementation, images 502 of different candidate holes (e.g., candidate sub-regions) are obtained and provided to a hole-level classifier 504 which determines a quality score for each candidate hole. In some examples, the images 502 are each separate micrograph images. In some examples, a patch-level image is obtained and the sub-regions correspond to different candidate holes within the patch-level image, and these individual sub-regions are identified, segmented, and analyzed individually. In the illustrated example, the sub-region quality assessment application 324 is implemented as a trained machine learning classifier. In an example, the classifier 504 is a supervised classifier that categorizes a hole into low or high quality based on a determined contrast transfer function (CTF) value. For example, the hole-level classifier 504 may determine the “CTFMaxRes” as the maximum resolution A for the fit of the contrast transfer function (CTF) to a given hole image. CTFMaxRes may be calculated, for example, from the 1D power spectrum of the hole image and estimate the maximum resolution for the detected CTF oscillations. In cryo-EM, CTFMaxRes provides an indirect metric for data quality. In general, the lower this value, the higher the quality of the hole image (e.g., micrograph). The Q-learning network (implementing the Cryo-Reinforcement learning (RL) techniques herein) will predict the quality of each hole from the patch-level image and plan the data collection trajectory. For simplicity, we define CTFMaxRes as CTF value for this paper.

Features 508 of different magnification-level images (e.g., of different group-level images) are generated from the features extraction application 326 and may be stored in the features database 330. In the illustrated example, these group-level image features include patch-level features, square-level features, and grid-level features, for example, where images at each magnification level have been captured and provided by the imager 302. The extracted features may be magnification-level dependent, and thus differ for the different images. In some examples, the same extracted features are obtained at each magnification level. These extracted features 508, along with the observation history, are provided to train a deep Q network (DQN) 510, to assess the status of all the candidate holes and suggest the best holes to look at next, based on analysis of generated Q-values 512 determined for each candidate hole. In the illustrated example, hole 514 has the highest Q-value and is determined to be the best next hole to image. A rewarding mechanism 516 drives the learning of DQN 510 in a feedback manner as shown. As discussed herein, the rewarding mechanism 516 may be a positive reward or a negative reward or a combination of such rewards. The reward may be automatically determined from predetermined factors and reward rules. The reward may be partially determined with input from a user.

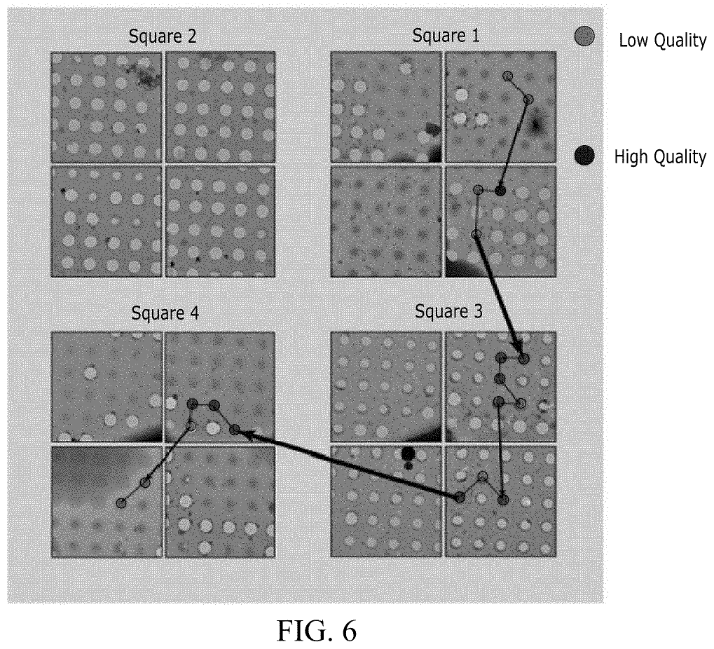

As shown in FIG. 6, an effective data collection session aims at finding a sequence of holes where there is a considerable portion of high-quality micrographs. Let H={hₗ|l= . . . nₕ} be a sequence of holes in a set of patches P sampled from different square-level and grid-level images (S and G) by the user. We denote Pₕₗ, Sₕₗ and Gₕₗ as the corresponding patch-level, square-level and grid-level images of hₗ, respectively. Also, ctf(hₗ) is a function representing the CTF value of a hole hₗ. Our goal is to identify a maximum subset of holes from H with low-CTF values in a given amount of time τ. Mathematically, this is equivalent to optimizing an object function as follows,

max Σₗ₌₀ⁿ^{ₕ}⁻¹(p(hₗ)−c(t(hₗ)))s·t·Σₗ₌₀ⁿ^{ₕ}⁻¹t(hₗ)≤τ (1)

where p(hₗ) be such an indicator function for a hole h that

$$p ( {h}_{i} ) = \{ \begin{matrix}1 & if ctf ( {h}_{i} ) \leq 6. \\ 0 & otherwise\end{matrix} \qquad ( 2 )$$

and C is a cost associated with the corresponding microscope operation and determined by the total amount of time t(hₗ) spent on hₗ. In this work, we define t(hₗ) in minutes by the movement of the microscope, i.e.,

$$t ( {h}_{i} ) = \{ \begin{matrix}2. & if {P}_{{h}_{i - 1}} = {P}_{{h}_{i}} ( same patch ) \\ 5. & if {P}_{{h}_{i - 1}} \neq {P}_{{h}_{i - 1}} , {S}_{{h}_{l - 1}} = {S}_{{h}_{l}} ( same square ) \\ 10. & if {S}_{{h}_{i - 1}} \neq {S}_{{h}_{i - 1}} , {G}_{{h}_{l - 1}} = {S}_{{h}_{l}} ( same grid ) \\ 20. & if {G}_{{h}_{i - 1}} = {G}_{{h}_{i}} ( different grid )\end{matrix}$$

Note that in practice, the time t can be more precisely calculated by considering the distance of the microscope movement and other factors.

By setting r(hₗ)=p(hₗ)−c(t(hₗ))), we can further rewrite Eq. 1 as

max Σₗ₌₀ⁿ^{ₕ}⁻¹r(hₗ)s·t·Σₗ₌₀ⁿ^{ₕ}⁻¹t(hₗ)≤τ (3)

Eq. 3 has the same form as the standard accumulative reward (without a discount factor) that is maximized in reinforcement learning. We now describe configurations of the present techniques that provide a solution to the path optimization problem in Eq. 3.

### Example Path Optimization Using Reinforcement Learning

In an example implementation, components of path optimization included following: the environment, the agent, states, actions, and rewards.

Environment: the atlas or grid.

Agent: a robot or user steering the microscope.

States. Let uᵢ∈{0,1} be a binary variable denoting the status of hole, i.e., visited or unvisited. Then a state S was represented by a sequence of holes and their corresponding statuses s=<(h₁,u₁), (h₂, u₂), . . . (hₙ_{ₕ},uₙ)> where n is the total number of holes.

Actions. An action aᵢ of the agent in the EM system was to move the microscope to the next target hole hᵢ for imaging. In the example, any unvisited hole had a chance to be picked by the agent as a target, thus the action space was large. Also, during tests, the number of holes (i.e., actions) was unknown. The Q-learning network was configured estimate the Q-value for every single hole, rather than all of them at once. As we show, this sufficed for handling the large action space in this example. In other examples, the Q-learning network may be configured to estimate Q-value for a set of holes.

Rewards. We assigned a positive reward 1.0 to the agent if an action resulted in a target hole with a CTF value less than 6.0 Å and 0.0 otherwise. The agent also received a negative reward depending on the operational cost associated with a hole visit. Specifically, we modeled the negative reward as c(hₗ)=1.0−e^{-β(t(h}^{ᵢ}^{)-t}^{ₒ}⁾(β>0, tₒ≥0). We empirically set β and to tₒ 0.185 and 2.0, which define the final reward function for our RL system as,

$$τ ( {a}_{i} ) = \{ \begin{matrix}1. & if ctf ( {h}_{i} ) < 6. \& {𝒫}_{{h}_{i - 1}} = {𝒫}_{{h}_{i}} \\ 0.57 & if ctf ( {h}_{i} ) < 6. \& {𝒫}_{{h}_{i - 1}} = {𝒫}_{{h}_{i}} \& {𝒮}_{{h}_{i - 1}} = {𝒮}_{{h}_{i}} \\ 0.23 & if ctf ( {h}_{i} ) < 6. \& {𝒮}_{{h}_{i - 1}} = {𝒮}_{{h}_{i}} \& {𝒢}_{{h}_{i - 1}} = {𝒢}_{{h}_{i}} \\ 0.09 & if ctf ( {h}_{i} ) < 6. \& {𝒢}_{{h}_{i - 1}} = {𝒢}_{{h}_{i}} \\ 0. & otherwise\end{matrix}$$

Deep Q-Learning: We applied a deep Q-learning approach to learn the policy for cryo-EM data collection. The goal of the agent was to select a sequence of actions (i.e., holes) based on a policy to maximize future rewards (i.e., the total number of low-CTF holes). In Q-learning, this was achieved by maximizing the action-value function Q*(s, α), i.e., the maximum expected return achievable by any strategy (or policy) π, given an observation (or state) s and some action α to take. In other words, Q*(s,a)−max_{π}E[Rₜ]sₜ=s, aₜ=a, π where Rₜ=Σₜ^{∞}γ^{t-1}rₜ was the accumulated future rewards with a discount factor γ. Q* can be found by solving the Bellman Equation as follows,

$${Q}^{*} ( s , a ) = {E}_{{s}^{′}} [ r + γ \begin{matrix}max \\ {a}^{′}\end{matrix} {Q}^{*} ( {s}^{′} , {a}^{′} ) \vert s , a ] \qquad ( 4 )$$

In practice, the state-action space can be enormous, thus a deep neural network parameterized by θ was used to approximate the action-value function. The network, also termed a Deep Q Network (DQN), was trained by minimizing the following loss functions L(θ),

L(θ)=E_{s,a,r,s′}[y−Q(s,a;θ)²] (5)

where y=E_{s′}[r+γ max_{a′}Q(s′,a′)|s, a] γ is the target for the current iteration. The derivatives of the loss function L(θ) are expressed as follows:

$${∇}_{θ} L ( θ ) = {E}_{s , a , r , {s}^{′}} [ ( r + γ \begin{matrix}max \\ {a}^{′}\end{matrix} Q ( {s}^{′} , {a}^{′} ; {θ}^{′} ) - Q ( s , a ; θ ) {∇}_{θ} Q ( s , a ; θ ) ]$$

Experience replay was further adopted to store into memory the transition at each time-step, i.e., (sₜ, aₜ, rₜ, sₜ₊₁), and then sample the stored samples for model update during training.

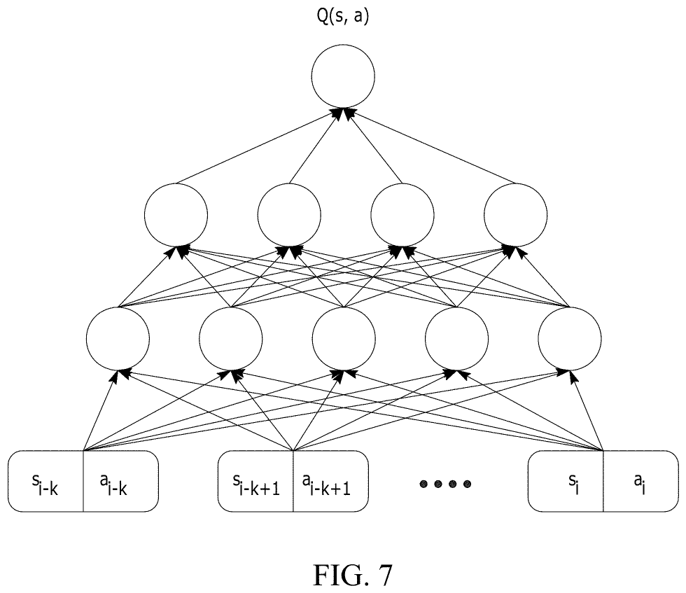

DQN: In this example, the action space was not fixed and could potentially grow large depending on the size of training data. To deal with this issue, the Q-learning network was configured to predict the Q-value for each hole (i.e. action) using one single output, as shown in FIG. 7. The Q-value for all the actions could then be batch processed and the E-greedy scheme was applied for action selection. The DQN in this example was a 3-layer fully connected network. The size of each layer was 128, 256 and 128, respectively.

Features to DQN: The quality of a hole was directly determined by its CTF value. Similarly, the number of low-CTF holes (ICTFs) in a hole-level image indicated the quality (or value) of the image, and in this example the RL policy prioritized high-quality patches first in planning. The same holds true for square-level and grid-level images. Based on this, input features to the DQN were chosen according to the quality of images at different levels. We also considered the information of microscope movement as it tells whether the microscope is exploring a new region or staying at the same region. The details of these features are in Table 1. A sequence of these features for the last k−1 visited holes as well as the current one to be visited were concatenated together to form the input to DQN. In this example, k was empirically set to 4.

TABLE 1
Input features to DQN

| Feature Type | Definition | Value |
|---|---|---|
| hole | is it low-CTF? | {0, 1} |
| | is it visited? | |
| patch/square/grid | # of unvisited holes | 0~150* |
| | # of unvisited ICTFs | |
| | # of visited holes | |
| | # of visited ICTFs | |
| microscope movement | going to a new patch-level image? | {0, 1} |
| | going to a new square-level image? | {0, 1} |
| | going to a new grid-level image? | {0, 1} |

*the maximum number of holes allowed in a grid-level image in our setting

Hole-level Classification: We trained the hole-level classifier offline by cropping out the holes in our data using the location provided in the meta data. There were a total of 2464 hole images for training and 1074 for testing. Using an offline classifier enabled fast learning of the Q function as only the Q-learning network was updated in training and its input features could be computed efficiently. However, in other examples, a configuration may jointly learn the classifier and DQN to further improve performance.

### Example Experiments

Dataset: To design and evaluate the performance of the example Cryo-EM system, we collected an “unbiased” cryo-EM dataset to provide a systematic overview of all squares, patches, holes, and micrographs within a defined region of a cryo-EM grid. Specifically, aldolase at a concentration of 1.6 mg/ml was dispensed on a support grid and prepared using a Vitrobot. Instead of picking the most promising squares and holes, we randomly selected 31 squares across the whole grid and imaged almost all the holes in these selected squares. This resulted in a dataset of 4017 micrographs from holes in these 31 squares. Overall, the data quality was poor, given that only 33.4% of the micrographs have a CTF below 6.0 Å. However, this made the dataset very suitable for developing and testing algorithms for data collection algorithms, because 1) a perfect algorithm will aim to find the best data from mostly bad micrographs, and 2) the “unbiasedness” of this dataset ensures that when an algorithm selects a hole, the corresponding micrograph, and its metric can be provided as feedback.

Training and Evaluation: We used the Tianshou reinforcement learning framework (i.e., Weng et al., “A highly modularized deep reinforcement learning library” arXiv preprint arXiv:2107.14171, 2021) to assess the reinforcement learning applied by the Q-learning network. Each model was trained with 20 epochs, using the Adam optimizer and an initial learning rate of 0.01. We set the duration in our system to 120 minutes for training, and evaluate the system at 120, 240, 360 and 480 minutes, respectively.

The main results were as follows.

Comparison with Baseline. We compared our approach with a greedy-based heuristic method. This method first performs a primary sorting on all the grid-level images by their quality (i.e., the number of low CTF holes) and then a secondary sorting on the patches of the same grid by the quality of patches. The sorted patches are visited in order, with only the holes classified as low CTFs considered. While being simple, this greedy approach serves as a strong baseline when the hole-level classifier is strong.

The offline classifiers used in this example were residual neural networks (ResNets) specifically ResNet18 (cryoRL-R18) and ResNet50, both of which achieve an accuracy around 89% in classifying holes (see Table 3). We further considered a perfect scenario where the holes were directly categorized by their CTF values. The method may be denoted by X-Y wherein X refers to a policy (i.e., the greedy baseline or our proposed technique) and Y is one of the classifiers, i.e., Resnet18 (R18), Resnet50 (R15) or ground truth (GT).

TABLE 3
Effects of classifier accuracy on cryoRL performance
(lCTF: low-CTF holes; hCTF: high-CTF holes)

| | Top-1 Accuracy | | | low-CFT holes identified by cryoRL | | | |
|---|---|---|---|---|---|---|---|
| Classifier | 1CTF | hCTF | All | τ = 120 | τ = 240 | τ = 360 | τ = 480 |
| R18* | 55.7 | 82.7 | 72.5 | 36.8 | 77.5 | 106 | 140 |
| R50* | 52.2 | 89 | 73.7 | 41.6 | 77.6 | 115.0 | 144 |
| R18 | 90.1 | 87.5 | 88.5 | 45.1 | 84.3 | 114.8 | 154.3 |
| R50 | 83.9 | 91.2 | 88.5 | 41.1 | 87.5 | 130.0 | 165.5 |

Table 2 reports the total rewards, the total number of low-CTF holes found (#ICTF) and the total number of holes visited (length) by each approach. All the results were averaged over 50 trials starting from random picked holes. For fairness, the random generator uses a fixed seed in all the experiments conducted below.

TABLE 2
Comparison cryoRL using a CTF cutoff of 6.0 with different baselines (#1CTFs:
total number of low-CTF holes identified; #visits: total number of
holes visited). All the results of cryoRL are averaged over 50 episodes.

| | | time = 120 minutes | | | time = 240 minutes | | |
|---|---|---|---|---|---|---|---|
| method | categorization | reward | #1CTFs | #visits | reward | #1CTFs | #visits |
| random | — | 0.4 ± 0.3 | 3.2 ± 1.4 | 9.1 ± 0.3 | 0.8 ± 0.4 | 6.8 ± 1.8 | 17.5 ± 0.8 |
| greedy-GT | groundtruth | 47.9 ± 2.9 | 49.4 ± 2.8 | 49.4 ± 2.8 | 88.8 ± 3.3 | 92.9 ± 3.1 | 92.9 ± 3.1 |
| cryoRL-GT | groundtruth | 42.5 ± 4.5 | 44.7 ± 4.0 | 45.2 ± 4.1 | 90.0 ± 4.6 | 93.7 ± 4.1 | 94.2 ± 4.2 |
| greedy-R18 | Resnet18 | 39.0 ± 3.6 | 39.0 ± 3.6 | 49.6 ± 2.9 | 66.4 ± 5.6 | 66.4 ± 5.6 | 96.2 ± 4.9 |
| greedy-R50 | Resnet50 | 41.1 ± 2.7 | 41.8 ± 2.5 | 49.3 ± 2.2 | 68.6 ± 3.5 | 69.3 ± 3.2 | 92.0 ± 3.5 |
| cryoRL-R18 | Resnet18 | 43.5 ± 3.7 | 45.1 ± 3.8 | 49.9 ± 2.0 | 81.2 ± 3.2 | 84.3 ± 3.2 | 98.5 ± 2.6 |
| cryoRL-R50 | Resnet50 | 40.2 ± 2.4 | 41.1 ± 2.5 | 44.7 ± 3.1 | 84.8 ± 1.9 | 87.5 ± 2.0 | 92.1 ± 2.4 |
| human | — | — | 31.9 ± 10.6 | 50 ± 0.0 | — | 77.4 ± 6.2 | 100 ± 0.0 |

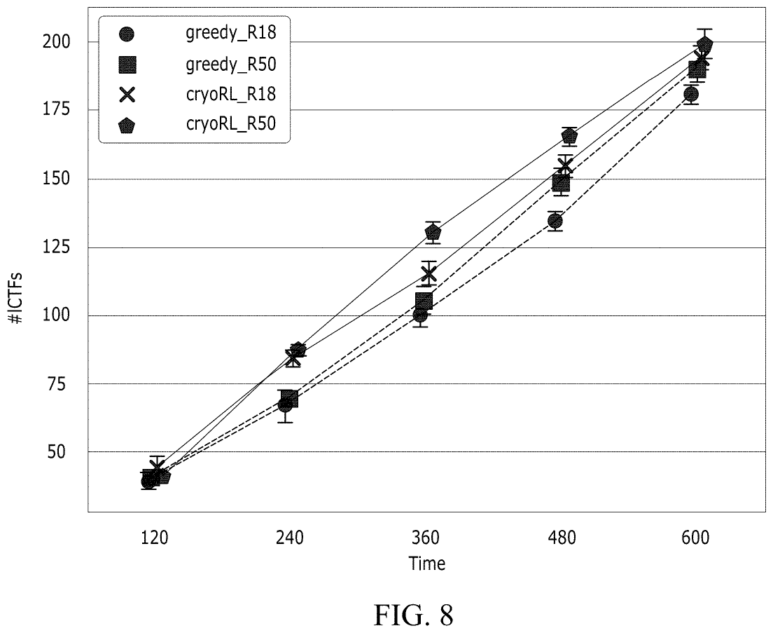

As can be seen from Table 2, our approach based on Resnet18 and Resnet50 produced promising results, being significantly better than the baseline (greedy-R18 and greedy-R50). Both cryoRL-R18 and cryoRL-R50 find over 40 and 90 holes within 120 and 240 minutes, respectively, compared to 48 and 97 holes identified by cryoRL-GT based on perfect ground-truth categorization. Further, in this example, our approach performed comparably against the baseline when ground truth was used for categorization, suggesting that the policy learned by our approach in such a case may behave greedily. FIG. 8 further illustrates the performance of Cryo-EM system over time. When the time duration is limited (for example, 120), minutes, the difference between all the approaches is small. This is because all of them can correctly focus on a few high-quality patches at the beginning. However, as time increases, our approach demonstrates clear advantages over the baseline, indicating the Q-learning network learns a better planning strategy than greedy.

Comparison with Human Performance. We developed a simulation tool to benchmark human performance against the performance of this example Q-learning network. Fifteen students from two different cryo-EM labs with various expertise levels were recruited in this human study. The users did not have any prior knowledge of this specific dataset before participating in this study. Patch-level images containing holes in the same dataset were shown to the user, and the user had either 50 or 100 chances to select the holes to take micrographs from, corresponding to the test duration of 120 or 240 minutes in the experiment. After each selection, the CTF value for the selected hole was provided to the user. The goal of the users is to select as many “good” holes as possible in 50 or 100 chances. Note that we did not penalize the users for switching to a different patch or square as we did in the Q-learning network. This encouraged the users to explore different patches initially and theoretically results in a better performance compared to penalties applied. Nevertheless, we found that the performance of Q-learning network was comparable to the human performance in both time durations (see, Table 2).

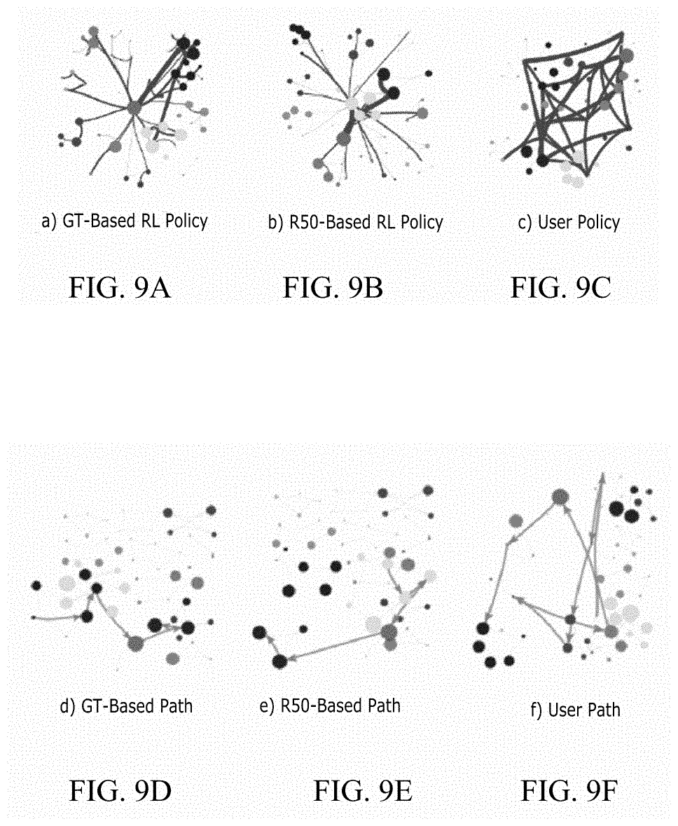

Policy behaviors. In various examples, the Q-learning network was designed to learn how to manipulate the microscope for efficient data collection. In FIG. 6, we compare and visualize the policies learned by our approach as well as the strategies used by human users. Specifically, we count how often the microscope visits a pair of hole-level images in the 50 trials of our results and illustrate such information by an undirected graph where the nodes represent the hole-level patches and the blue edges between two patches highlight the frequency of them being visited. Note that the node size here indicated the quality of a patch, and the color represented patches from the same grid image connected by light grey edges. Intuitively, a good policy should show strong connections between large-sized nodes. As observed in FIG. 6, the ground-truth-based RL policy (FIG. 9A)) explored patches more aggressively than the Resnet50 RL policy, which demonstrates a more conservative behavior and tends to stay on a few high-quality patches only. As opposed to the learned policies, the behavior of human users was random, with a lot of more patches being visited. This is because the users were not penalized for switching different patches in the human study, and may also be due to the large variance in the user expertise. FIG. 6 further shows a path trajectory planned by each policy as well as one from a user.

### Ablation Study

We applied the present techniques in an example that investigated how hole classification accuracy, time duration, features, and rewarding affected the performance (i.e., the total number a low-CTF holes in a given amount of time). The experiments below were based on Resnet50 unless specified otherwise.

Effects of classification accuracy: The hole-level classifiers based on Resnet18 and Resnet50 performed well on the data, achieving an accuracy of ˜89%. To determine the effect of hole classification accuracy on Q-learning, we trained two under-performing classifiers R18* and R50* with a ˜73% accuracy and applied them to learn Q-learning. Table 3 lists the top-1 accuracies of low-CTF and high-CTF holes based on different classifiers as well as the corresponding total number of ICTFs identified under different time durations. As shown in the table, degraded performance in classification resulted in a performance drop in the Q-learning network. Nevertheless, the comparable performance between cryoRL-R50* and cryoRL-R18 suggested that a modest classifier on low-CTF holes was sufficient for the Q-learning network to converge on good holes as long as the classifiers does not suffer from too many falsely classified low-CTF holes.

Effects of Time Duration: In principle, the time duration T used in training the Q-learning network controls the degree of interaction of the agent with the data. A small τ limits the Q-learning network to a few high-quality patches only, which might result in a more conservative policy that underfits. Table 4 confirms this potential issue, showing inferior performance when a short duration of 120 minutes is used for training.

TABLE 4
Effects of time duration used in training on cryoRL performance.

| | |
|---|---|
| Training | Test Duration |

| Duration | T = 120 | T = 240 | T = 360 | T = 480 |
|---|---|---|---|---|
| τ = 120 | 40.4 | 82.1 | 123.1 | 163.4 |
| τ = 240 | 41.1 | 87.5 | 130.0 | 165.5 |
| τ = 360 | 45.7 | 90.2 | 125.7 | 163.5 |

Performance of different features: The features we designed in Table 1 can be computed on either hard or soft hole-level categorization from the classifier. In addition, the training features can be based on hole-level categorization either from the true CTF values (gt) or the classifier (pred). We compared the performance of different feature combinations used for training and for tests in Table 5. From this analysis, we conclude that the model using hard categorization from the classifier for both training and test performs the best overall.

TABLE 5
Effects of different features on cryoRL-R50 performance.

| Features | | | Duration (minutes) | | | |
|---|---|---|---|---|---|---|
| training | test | score | τ = 120 | τ = 240 | τ = 360 | τ = 480 |
| gt | pred | hard | 40.7 | 85.8 | 123.5 | 157.6 |
| pred | pred | hard | 41.1 | 87.5 | 130.0 | 165.5 |
| pred | pred | soft | 42.5 | 81.5 | 127.2 | 165.9 |

gt: ground truth;
pred: prediction

Effects of Rewarding Strategies: In our approach, the rewards used in policy learning were empirically determined. To check the potential impact of different rewards on the performance of the present techniques, we trained more Q networks by doubling the reward for a) square switching; b) grid switching; and c) both. These changes are intended to encourage more active exploration of the data. As shown in Table 6, increasing the reward for square switching leads to better performance than the default setting, suggesting that reward mechanism optimization in the present techniques can be adjusted for affecting performance as desired.

TABLE 6
Effects of Different rewards on cryoRL's performance

| Rewards | | Duration (minutes) | | | |
|---|---|---|---|---|---|
| square-level | grid-level | τ = 120 | τ = 240 | τ = 360 | τ = 480 |
| 0.23 (default) | 0.09 (default) | 41.1 | 87.5 | 130.0 | 165.5 |
| 0.23 (×2) | 0.09 | 43.0 | 87.0 | 131.1 | 172.0 |
| 0.23 | 0.09 (×2) | 41.6 | 86.9 | 129.5 | 165.9 |
| 0.23 (×2) | 0.09 (×2) | 41.8 | 80.8 | 124.7 | 163.3 |

Thus, as shown, the present techniques include systems and methods that combine supervised classification and deep reinforcement learning that can provide new electron microscopy techniques for data collection, in particular, new cryo-EM techniques that we call cryoRL. The techniques not only return the quality predictions for lower magnified hole level images, but can also plan the trajectory for data acquisition. The present techniques provide the first machine learning-based algorithm in Cryo-EM data collection.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the target matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding; and no unnecessary limitations should be understood therefrom, as modifications within the scope of the invention may be apparent to those having ordinary skill in the art.

What is claimed:

1. A method for performing electron microscopy on a sample, the method comprising:
receiving, by one or more processors, images of a grid structure comprising a plurality of sub-regions, wherein the images of the grid structure contain (i) a first subset of candidate sub-region images captured at a first magnification level and each of a different candidate sub-region and (ii) one or more group-level images captured at a second magnification level and containing a plurality of the different candidate sub-region;
providing, by the one or more processors, the first subset of the images to a trained sub-region quality assessment application and outputting, from the trained sub-region quality assessment application, a quality score for each candidate sub-region;
generating, by the one or more processors, from the quality scores for each candidate sub-region image, group-level features for the group-level images, using a group-level feature extraction application;
applying, by the one or more processors, the quality scores for each of the candidate sub-region images and the group-level extraction features to a trained Q-learning network, the trained Q-learning network determining Q-values for each candidate sub-region and identifying a next sub-region amongst the candidate sub-regions; and
capturing one or more a micrograph images of the next sub-region.

2. The method of claim 1, wherein the trained sub-region quality assessment application is configured to classify each candidate sub-region based on contrast transfer function metrics.

3. The method of claim 2, wherein the trained sub-region quality assessment application is configured to classify each candidate sub-region has having a low quality or a high quality based on contrast transfer function metrics.

4. The method of claim 1, wherein the trained sub-region quality assessment application is a supervised classifier.

5. The method of claim 1, wherein the trained sub-region quality assessment application is a regression-based classifier.

6. The method of claim 1, wherein the candidate sub-regions are geometrical hole-shaped regions.

7. The method of claim 1, wherein each sub-region of the grid is sized to contain a single particle of the sample.

8. The method of claim 1, wherein the trained Q-learning network is a multi-fully-connected layer deep Q-network configuration.

9. The method of claim 8, wherein a fully-connected layer of the trained Q-learning network comprises a plurality of observation state and action pairs.

10. The method of claim 1, wherein the trained Q-learning network is a deep reinforcement learning network.

11. The method of claim 1, further comprising:
in response to capturing the micrograph image of the next sub-region, determining a reward score of the micrograph image of the next sub-region;
providing the reward score of the micrograph image of the next sub-region to the trained Q-learning network; and
updating a rewards decision of the trained Q-learning network for determining Q-values for subsequent candidate sub-regions.

12. The method of claim 1, wherein the trained Q-learning network is configured to identify the next sub-region by determining a decisional cost associated with imaging each candidate sub-region and identifying, as the next sub-region, the candidate sub-region with the lowest decisional cost.

13. The method of claim 1, wherein the group-level images comprise patch-level images each of a patch-level region containing a plurality of the candidate sub-regions, square-level images each of a square-level region containing a plurality of the patch-level regions, and/or grid-level images each of a grid-level region containing a plurality of square-level regions.

14. The method of claim 1, wherein generating the group-level extraction features comprises determining, for each group-level image, a number of candidate sub-regions, a number of previously imaged sub-regions, a number of candidate sub-regions with a low quality score, and/or a number of candidate sub-regions with a high quality score.

15. A system for performing electron microscopy on a sample, the system comprising:
one or more processors; and
a deep-reinforcement learning platform including a trained sub-region quality assessment application, a feature extraction application, and trained Q-learning network;
wherein the deep-reinforcement learning platform includes computing instructions configured to be executed by the one or more processors to:
receive images of a grid structure comprising a plurality of sub-regions, wherein the images of the grid structure contain (i) a first subset of candidate sub-region images captured at a first magnification level and each of a different candidate sub-region and (ii) one or more group-level images captured at a second magnification level and containing a plurality of the different candidate sub-region; and
provide the first subset of the images to the trained sub-region quality assessment application;
wherein the trained sub-region quality assessment application includes computing instructions configured to be executed by the one or more processors to determine and output a quality score for each candidate sub-region;
wherein the feature extraction application includes computing instructions configured to be executed by the one or more processors to:
generate from the quality scores for each candidate sub-region image, group-level features for the group-level images; and
apply the quality scores for each of the candidate sub-region images and the group-level extraction features to the trained Q-learning network;
wherein the trained Q-learning network includes computing instructions configured to be executed by the one or more processors to determine Q-values for each candidate sub-region and identify a next sub-region amongst the candidate sub-regions.

16. The computing system of claim 15, the deep-reinforcement learning platform including a rewards application, wherein the rewards application includes computing instructions configured to be executed by the one or more processors to:
in response to capturing a micrograph image of the next sub-region, determine a reward score of the micrograph image of the next sub-region; and
provide the reward score of the micrograph image of the next sub-region to the trained Q-learning network; and
wherein the trained sub-region quality assessment application includes computing instructions configured to be executed by the one or more processors to update the trained Q-learning network for determining Q-values for subsequent candidate sub-regions.

17. A non-transitory computer-readable storage medium storing executable instructions that, when executed by a processor, cause a computer to:
receive, by one or more processors, images of a grid structure comprising a plurality of sub-regions, wherein the images of the grid structure contain (i) a first subset of candidate sub-region images captured at a first magnification level and each of a different candidate sub-region and (ii) one or more group-level images captured at a second magnification level and containing a plurality of the different candidate sub-region;
provide, by the one or more processors, the first subset of the images to a trained sub-region quality assessment application and output, from the trained sub-region quality assessment application, a quality score for each candidate sub-region;
generate, by the one or more processors, from the quality scores for each candidate sub-region image, group-level features for the group-level images, using a group-level feature extraction application;
apply, by the one or more processors, the quality scores for each of the candidate sub-region images and the group-level extraction features to a trained Q-learning network, the trained Q-learning network determining Q-values for each candidate sub-region and identifying a next sub-region amongst the candidate sub-regions; and
capture one or more a micrograph images of the next sub-region.
